(19) United States
(12) Patent Application Publication
(10) Pub. No.: US 2014/0315634 A1
(43) Pub. Date: Oct. 23, 2014

(54) Game Machine

(71) Applicant: OMRON CORPORATION, Kyoto-shi (JP)

(72) Inventors: Tatsuya ADACHI, Ichinomiya-shi (JP); Mitsunori SUGIURA, Ama-gun (JP)

(73) Assignee: OMRON CORPORATION, Kyoto-shi (JP)

(21) Appl. No.: 14/219,615

(22) Filed: Mar. 19, 2014

(30) Foreign Application Priority Data
Apr. 18, 2013 (JP) 2013-087479

(51) Int. Cl. A63F 13/00

(52) U.S. Cl. CPC A63F 13/00
USPC 463/31

(57) ABSTRACT

A game machine including a request command holding unit configured to hold a request command for making a request of an image analyzer for an image parameter that is used for determination as to whether or not to execute a performance, an execution condition holding unit configured to hold an execution condition to be satisfied by the image parameter, a request command outputting unit configured to output to the image analyzer the request command that is held in the request command holding unit while mapped with an executable performance, when the executable performance is decided, an image parameter acquiring unit configured to acquire an image parameter, and a performance executing unit configured to execute the executable performance when the acquired image parameter satisfies the execution condition that is held in the execution condition holding unit while mapped with the executable performance.

### CROSS REFERENCE TO RELATED APPLICATION

This application is related to and claims the benefit of Japanese Patent Application Number 2013-087479 filed on 18 Apr. 2013, the contents of which are herein incorporated by reference in their entirety.

### BACKGROUND

1. Field

The present invention relates to a game machine.

2. Related Art

Japanese Unexamined Patent Publication No. 2012-196351 discloses providing motion sensors in a horizontal direction and a vertical direction on a periphery of a game board of a pachinko game machine and detecting horizontal and vertical positions of a player's hand by use of the motion sensors.

### SUMMARY

A game machine is provided which executes a performance based on an image parameter derived by an image analyzer from an image captured by an imaging unit, the game machine including a request command holding unit configured to hold a request command for making a request of the image analyzer for an image parameter that is used for determination as to whether or not to execute a performance, while mapping the image parameter with each of a plurality of performances, an execution condition holding unit configured to hold an execution condition to be satisfied by the image parameter, while mapping the request command with each of the plurality of performances, a request command outputting unit configured to output to the image analyzer the request command that is held in the request command holding unit while mapped with an executable performance, when the executable performance is decided, an image parameter acquiring unit configured to acquire an image parameter that is outputted from the image analyzer in response to the request command, and a performance executing unit configured to execute the executable performance when the image parameter acquired from the image parameter acquiring unit satisfies the execution condition that is held in the execution condition holding unit while mapped with the executable performance.

### BRIEF DESCRIPTION OF THE DRAWINGS

FIG. 1 is a view showing an example of a schematic front view of a game machine provided with an image processing device according to the present embodiment;

FIG. 2 is a view showing an example of an external perspective view of the image processing device according to the present embodiment;

FIG. 3 is a view showing an example of movement of a hand as a detection object;

FIG. 4 is a view showing an example of images in the case of moving the hand in a Z-axis minus direction with a wrist taken as a base point;

FIG. 5 is a diagram showing an example of a functional block of the image processing device according to the present embodiment;

FIG. 6A is a diagram for explaining labeling processing;

FIG. 6B is a diagram for explaining labeling processing;

FIG. 7 is a diagram showing an example of a functional block of the game machine according to the present embodiment;

FIG. 8 is an example of a table where a performance content is associated with a request command;

FIG. 9A is a flowchart showing an example of a procedure for a movement detecting unit performing movement detection processing to detect movement of a subject along an X-axis direction;

FIG. 9B is a flowchart showing an example of a procedure for the movement detecting unit performing movement detection processing to detect movement of the subject along a Y-axis direction;

FIG. 9C is a flowchart showing an example of a procedure for the movement detecting unit performing movement detection processing to detect movement of the subject along a Z-axis direction;

FIG. 10 is a flowchart showing an example of a processing procedure for an image analyzer;

FIG. 11 is a flowchart showing an example of a processing procedure for the game machine when a game ball enters a winning hole; and

FIG. 12A is a view showing an example of performance screens that are displayed in the case of winning.

FIG. 12B is a view showing an example of performance screens that are displayed in the case of winning

FIG. 12C is a view showing an example of performance screens that are displayed in the case of winning

### DETAILED DESCRIPTION

Although the present invention will be described below through an embodiment of the invention, the following embodiment does not restrict the invention according to the claims. Further, all combinations of characteristics described in the embodiment are not necessarily essential for the solving means of the invention.

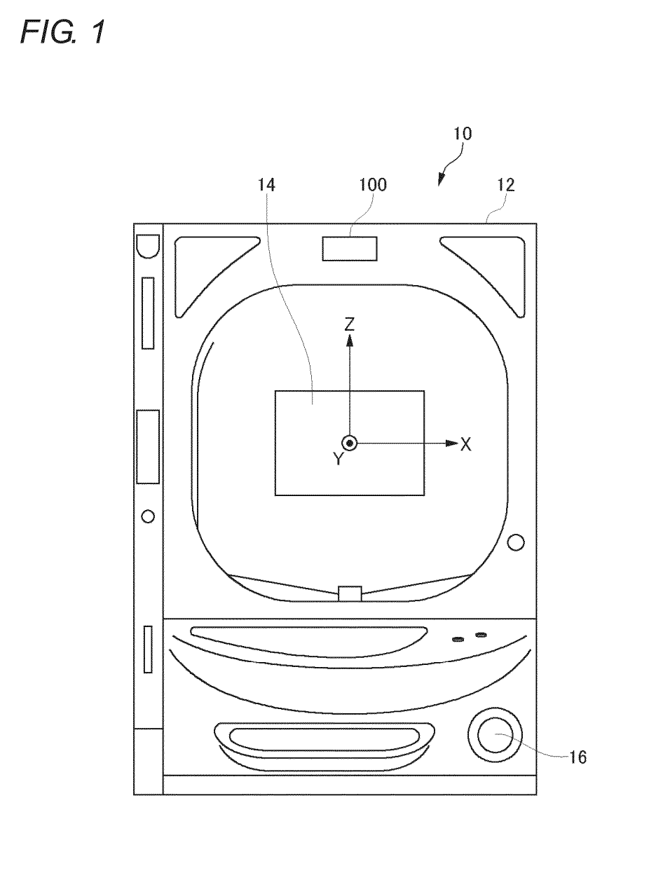

FIG. 1 is a view showing an example of a schematic front view of a game machine 10 provided with an image processing device 100 according to the present embodiment. The game machine 10 is provided with a casing 12, a display device 14, a handle switch 16 and the image processing device 100.

The display device 14 is arranged in a game region of the casing 12. The display device 14 displays a variety of images for performances. The display device 14 is provided with a display screen such as a liquid crystal display. With advancement of a game by a player, for example, the display device 14 displays a decoration design for notifying the player of a design lottery result or displays a performance image due to appearance of a character or an item. The handle switch 16 is operated by the player in the case of launching a game ball via a ball launch device. The image processing device 100 derives a plurality of image parameters for detecting a variety of variations in movement and the like of the subject in the detection object region. The game machine 10 specifies the kind of variation to be detected as to the subject based on a content of an executable performance. The game machine 10 acquires an image parameter in accordance with the kind of variations from the image processing device 100. The game machine 10 detects a specific variation as to the subject based on the acquired image parameter, and when detecting the specific variation as to the subject, the game machine 10 executes a performance of making the display device 14 display an image in accordance with the specific variation.

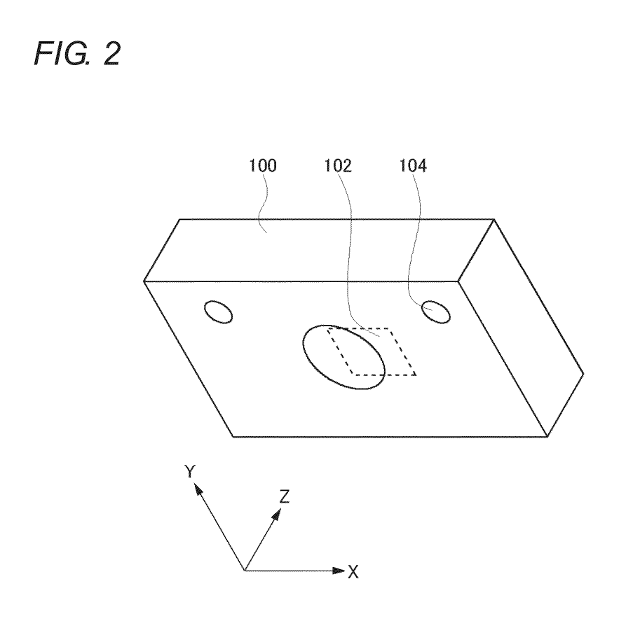

FIG. 2 is a view showing an example of an external perspective view of the image processing device 100. The image processing device 100 is provided with an imaging unit 102 and an infrared light emitting unit 104. The infrared light emitting unit 104 irradiates the detection object region for the subject with infrared rays. The imaging unit consecutively captures a plurality of images in accordance with a received light amount of reflected light of specific-wavelength light, with which the detection object region for detecting movement of the subject is irradiated. The imaging unit 102 has a visible-light cut filter, an imaging element and an image generating unit. The visible-light cut filter filters out visible light out of the reflected light having been reflected on the subject, and transmits infrared light therethrough. The imaging element performs photoelectric conversion on the infrared light transmitted through the visible-light cut filter, and outputs an image signal. The image generating unit performs image processing on the image signal outputted from the imaging element, thereby generating an image.

The image processing device 100, for example, takes a player's hand as a subject and derives image parameters for detecting movement of the player's hand along an X-axis direction, a Y-axis direction and a Z-axis direction. The game machine 10 detects movement of the player's hand along the X-axis direction, the Y-axis direction and the Z-axis direction based on the image parameters. It is to be noted that a first direction vertical to the imaging surface of the imaging unit 102, namely a light-receiving surface of the imaging element, is set to the Z-axis direction, a second direction parallel to the imaging surface is set to the X-axis direction, and a third direction parallel to the imaging surface and vertical to the second direction is set to the Y-axis direction.

Here, in the case of the subject moving away from the imaging unit 102 along a Z-axis direction, namely in the case of the subject moving in the Z-axis minus direction, it is considered that an area of the subject gradually becomes smaller. Further, in the case of the subject moving closer to the imaging unit 102 along a Z-axis direction, namely in the case of the subject moving in a Z-axis plus direction, it is considered that the area of the subject gradually becomes larger. It is thus considered that the game machine 10 detects movement of the subject along the Z-axis direction based on a variation in area of the subject included in the image captured by the imaging unit 102.

Further, it is considered that the game machine 10 detects movement of the subject along the X-axis direction or the Y-axis direction parallel to the imaging surface based on a variation in gravity-center coordinates of the subject included in the image captured by the imaging unit 102.

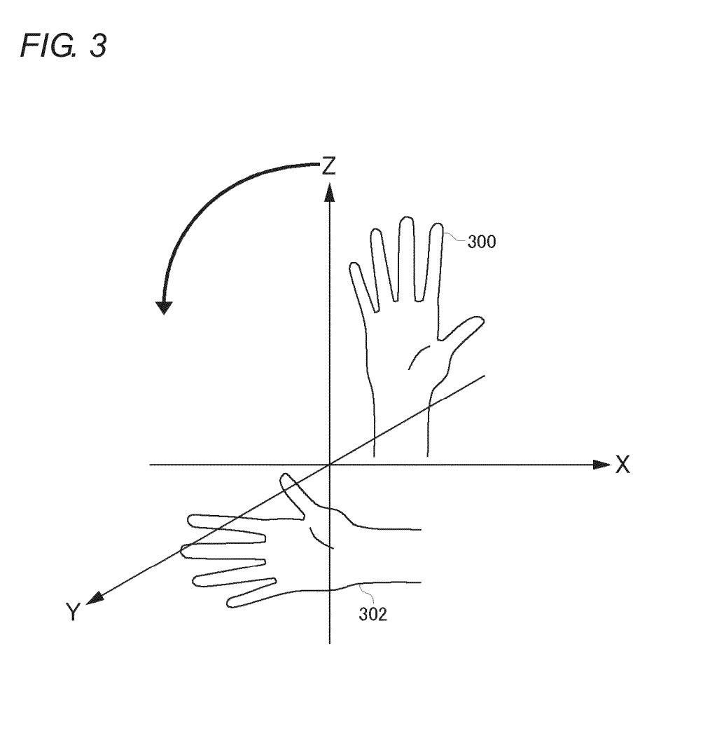

However, as shown in FIG. 3, when the player for example moves his or her hand in the Z-axis minus direction with its wrist taken as a base point so as to bring the hand into a state of numeral 302 from numeral 300, in the case of detecting movement of the subject based only on the variation in area or the variation in gravity-center coordinates of the subject within the image, it may not be possible to accurately detect movement of the subject.

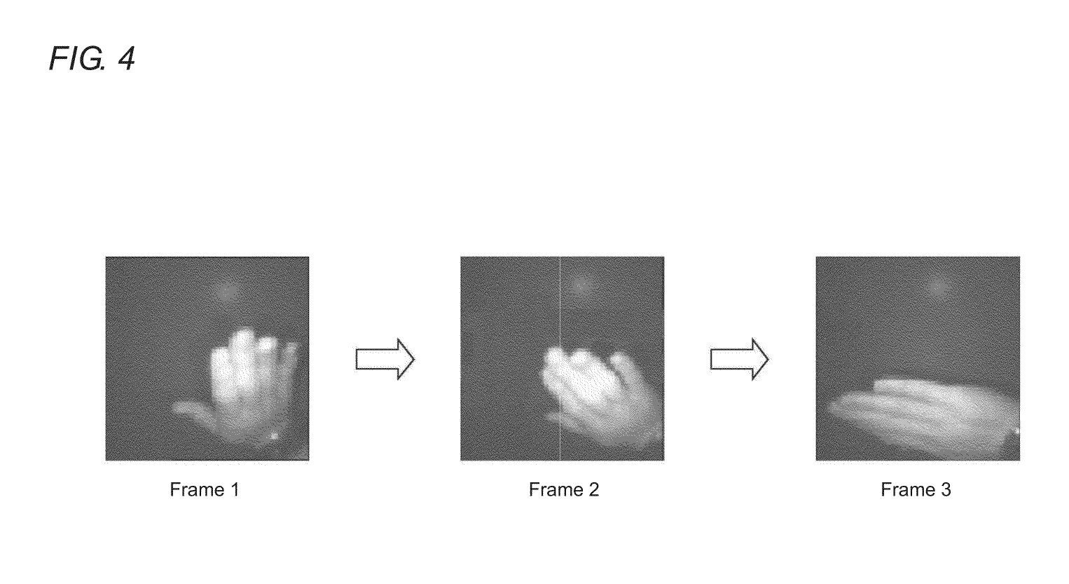

FIG. 4 shows an example of images outputted from the imaging unit 102 in the case of moving the hand in the Z-axis minus direction with the wrist taken as the base point. In the case of movement in the Z-axis direction with the wrist taken as the base point, there is a small variation in area of the subject since a portion from the wrist to finger tips is constantly included in the image as the subject. Further, in the case of movement in the Z-axis minus direction with the wrist taken as the base point, a direction of the hand included in the image changes, and the area of the subject does not become smaller. As the subject moves away from the imaging unit 102, the area of the subject becomes larger.

On the other hand, as the distance between the subject and the imaging unit 102 is longer, the infrared light reflected on the subject is disadvantageously diffused. Therefore, as the distance between the subject and the imaging unit 102 is longer, the amount of the infrared light incident on the imaging unit 102 is smaller. That is, as the distance between the subject and the imaging unit 102 is longer, the luminance of the subject included in the image is lower. Therefore, when the luminance of the subject varies to be lower, the subject may be moving in the Z-axis minus direction. Further, when the luminance of the subject varies to be higher, the subject may be moving in the Z-axis plus direction.

In the case of detecting movement of the subject along the Z-axis direction, the game machine 10 according to the present embodiment acquires as the image parameters the area and the luminance of the subject from the image processing device 100 and accurately detects movement of the subject along the Z-axis direction based on the area and the luminance of the subject.

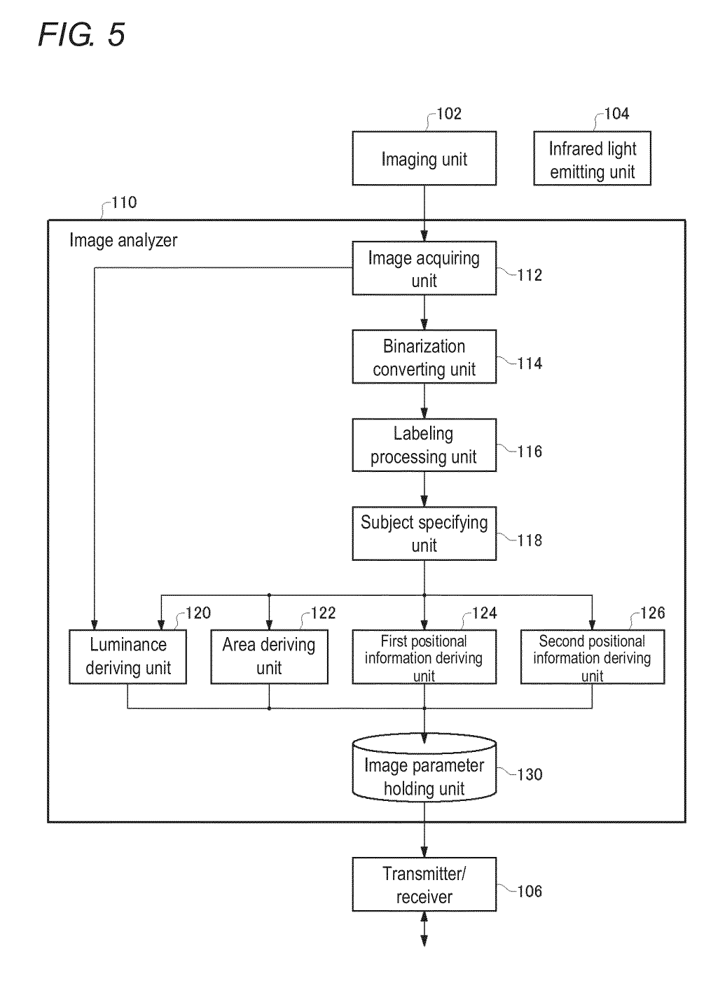

FIG. 5 shows an example of a functional block of the image processing device 100. The image processing device 100 is provided with the imaging unit 102, the infrared light emitting unit 104, an image analyzer 110, and a transmitter/receiver 106.

The infrared light emitting unit 104 irradiates a previously set detection object region with pulse-like infrared rays. The imaging unit 102 outputs an image in accordance with the received light amount of the infrared rays reflected from the subject existing in the detection object region. The image analyzer 110 analyzes the image outputted from the imaging unit 102 to derive an image parameter for detecting movement of the subject. The transmitter/receiver 106 receives a request command from the game machine, and in response to the request command, the transmitter/receiver 106 returns an image parameter for the game machine 10 detecting the specific moving direction as to the subject.

The image analyzer 110 is provided with an image acquiring unit 112, a binarization converting unit 114, a labeling processing unit 116, a subject specifying unit 118, a luminance deriving unit 120, an area deriving unit 122, a first positional information deriving unit 124, a second positional information deriving unit 126, and an image parameter holding unit 130.

The image acquiring unit 112 acquires a plurality of images consecutively captured by the imaging unit 102, and provides them to the binarization converting unit 114 and the luminance deriving unit 120. The image outputted from the imaging unit 102 may be an 8-bit grayscale image showing a monochrome image where each pixel constituting the image has 256 kinds of gradation. The binarization converting unit 114 performs binarization processing on each of the provided plurality of images, and outputs the binarized images. The binarization converting unit 114 outputs the binarized image where a pixel with a luminance not lower than a previously set threshold luminance is taken as a white pixel and a pixel with a luminance lower than the threshold luminance is taken as a black pixel, out of each pixel constituting the 8-bit grayscale image.

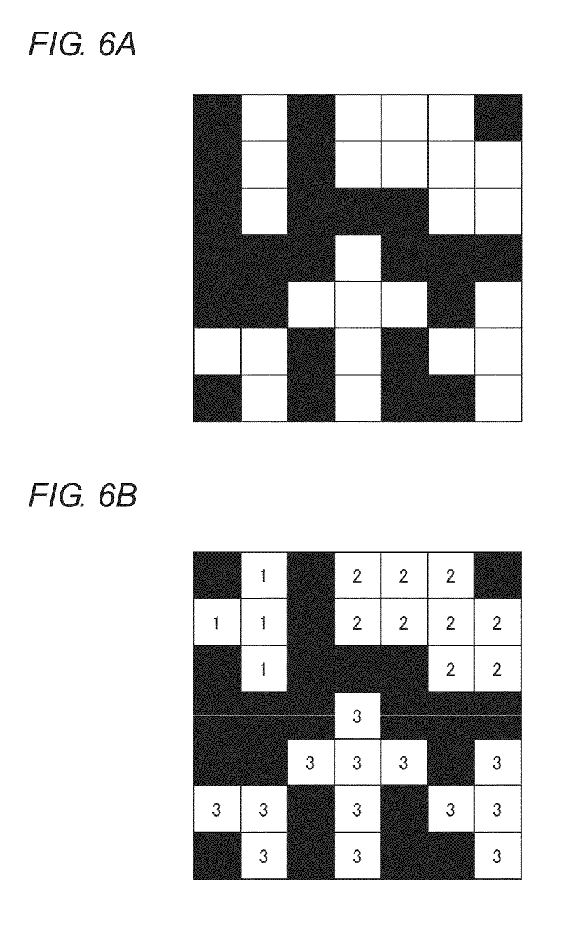

The labeling processing unit 116 provides the same label to coupled white pixels out of each pixel constituting the binarized image, to divide those into groups of white pixels to be subject candidates. The labeling processing unit 116 may provide the same label to adjacent white pixels in eight directions including vertical, horizontal and oblique directions. For example, the labeling processing unit 116 performs labeling processing on a binarized image as shown in FIG. 6A, and performs labeling on each white pixel as shown in FIG. 6B. Thereby, the labeling processing unit 116 divides the white pixels which become subject candidates into groups.

The subject specifying unit 118 specifies the subject based on the binarized image subjected to the labeling processing. The subject specifying unit 118 specifies as the subject the white pixel group having the largest number of pixels provided with the same label. For example, in such a labeling-processed binarized image as shown in FIG. 6B, the subject specifying unit 118 specifies a white pixel group provided with a label “3” as the subject.

The luminance deriving unit 120 derives an average luminance of the subject with respect to each of a plurality of pixels. The luminance deriving unit 120 extracts each pixel corresponding to a position of the white pixel group constituting the subject which is specified by the subject specifying unit 118, out of each pixel constituting the 8-bit grayscale image. The luminance deriving unit 120 may derive an average luminance of a luminance (gradation value) of each extracted pixel, as the luminance of the subject.

The area deriving unit 122 derives an area of the subject in each of the plurality of images. The area deriving unit 122 may derive the number of white pixel groups constituting the subject which was specified by the subject specifying unit 118, thereby deriving the area of the subject in each of the plurality of images.

The first positional information deriving unit 124 derives as first positional information an X-coordinate of the gravity center of the subject in each of the plurality of images. The second positional information deriving unit 126 derives as second positional information a Y-coordinate of the gravity center of the subject in each of the plurality of images.

The image parameter holding unit 130 holds a plurality of image parameters each for detecting movement along the specific moving direction as to the subject. The image parameter holding unit 130 holds, as the image parameters, gravity-center coordinates of the subject in the X-axis direction and the Y-axis direction, the area of the subject and the luminance of the subject.

In accordance with the request command from the game machine 10, the transmitter/receiver 106 transmits to the game machine 10 an image parameter for detecting movement in the specific moving direction as to the subject out of the plurality of image parameters held in the image parameter holding unit 130.

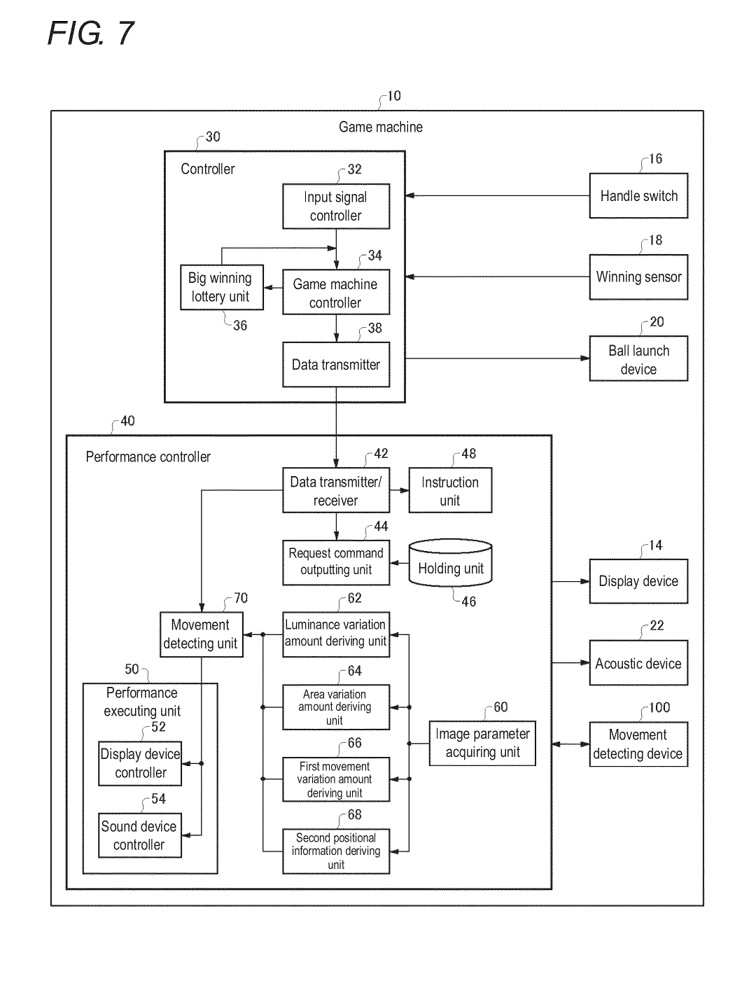

FIG. 7 is an example of a functional block of the game machine 10 according to the present embodiment. In the present embodiment, the game machine 10 is a pachinko machine. However, the game machine 10 may be another game machine such as a pachinko-slot machine.

The game machine 10 is provided with the display device 14, the handle switch 16, a winning sensor 18, a ball launch device 20, an acoustic device 22, a controller 30, a performance controller 40, and the image processing device 100.

The display device 14 displays an image corresponding to a performance that is executed with advancement of a game by the player. The handle switch 16 launches a game ball via the ball launch device 20 in accordance with an operation by the player. The winning sensor 18 detects entry of the game ball into a previously set winning hole on the game board, and outputs a winning signal. The ball launch device 20 launches the game ball in accordance with an operation amount of the handle switch 16. The acoustic device 22 outputs a voice corresponding to a performance that is executed with advancement of the game by the player.

The controller 30 controls the whole of the game machine 10. The controller 30 is provided with an input signal controller 32, a game machine controller 34, a big winning lottery unit 36, and a data transmitter 38. The input signal controller 32 detects input of the winning signal from the winning sensor 18, and notifies the game machine controller 34 of a lottery signal. When sensing the lottery signal from the input signal controller 32, the game machine controller 34 notifies the big winning lottery unit 36 of the lottery signal, and receives a lottery result from the big winning lottery unit 36. Further, the game machine controller 34 outputs a performance command in accordance with the lottery result to the performance controller 40 via the data transmitter 38. The big winning lottery unit 36 performs big winning lotteries in accordance with the lottery signal from the game machine controller 34, and notifies the game machine controller 34 of a lottery result. The data transmitter 38 transmits the performance command from the game machine controller 34 to the performance controller 40.

The performance controller 40 has a data transmitter/receiver 42, a request command outputting unit 44, a holding unit 46, an instruction unit 48, a performance executing unit 50, an image parameter acquiring unit 60, a luminance variation amount deriving unit 62, an area variation amount deriving unit 64, a first movement variation amount deriving unit 66, a second movement variation amount deriving unit 68 and a movement detecting unit 70. The performance executing unit 50 includes a display device controller 52 and a sound device controller 54.

The data transmitter/receiver 42 receives a performance command from the controller 30, and outputs a performance command to the request command outputting unit 44, the instruction unit 48 and the movement detecting unit 70.

The holding unit 46 functions as a request command holding unit to hold a request command for making a request of the image processing device 100 for an image parameter that is used for determination as to whether or not to execute a performance, while mapping the request command with each of a plurality of performances. The holding unit 46 functions as the execution condition holding unit for holding an execution condition to be satisfied by the image parameter, while mapping the condition with each of the plurality of performances.

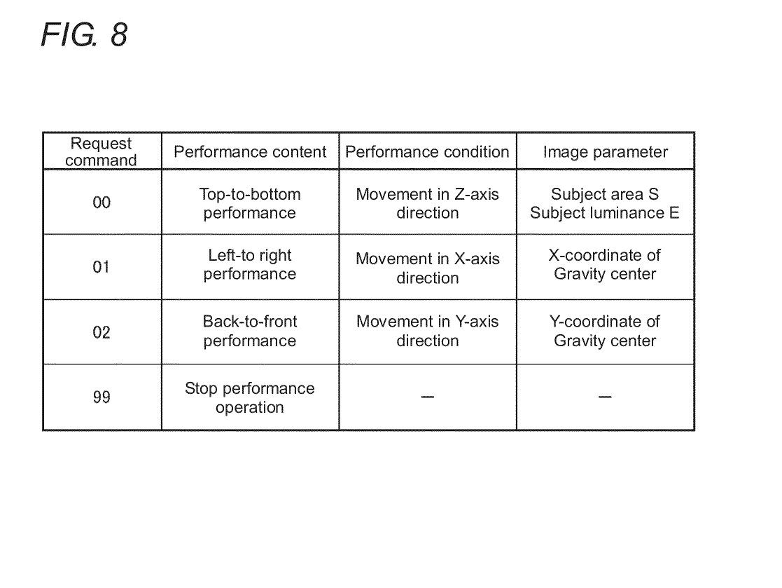

FIG. 8 shows an example of contents held in the holding unit 46. The holding unit 46 may hold an image parameter, which is necessary for detecting a performance content, a performance condition showing a moving direction of the subject to be detected for executing a performance, and movement as to a moving direction shown in the performance condition, while mapping them with the request command.

When the executable performance is decided, the request command outputting unit 44 outputs to the image processing device 100 the request command that is held in the holding unit 46 while mapped with the executable performance. For example, in the case of executing a performance when the player's hand moves along the Z-axis direction, the request command outputting unit 44 outputs to the image processing device 100 a signal showing “00” as a first request command in order to make a request for an area and a luminance of the subject as the image parameter. In the case of executing a performance when the player's hand moves along the X-axis direction, the request command outputting unit 44 outputs to the image processing device 100 a signal showing “01” as a second request command in order to make a request for an X-coordinate of the gravity center of the subject as the image parameter. In the case of executing a performance when the player's hand moves along the Y-axis direction, the request command outputting unit 44 outputs to the image processing device 100 a signal showing “02” as a third request command in order to make a request for a Y-coordinate of the gravity center of the subject as the image parameter.

When the movement detection result satisfies previously set game conditions, the instruction unit 48 instructs the player to move the hand in a moving direction corresponding to the game conditions. When the movement detection result satisfies a previously set first game condition, the instruction unit 48 functions as a first instruction unit which instructs the player to move the hand in the first direction (Z-axis direction), e.g., in a top-to-bottom direction or a bottom-to-top direction with respect to the game machine. When the movement detection result satisfies a previously set second game condition, the instruction unit 48 functions as a second instruction unit which instructs the player to move the hand in the second direction (X-axis direction), e.g., in a left-to-right direction or a right-to-left direction with respect to the game machine. When the movement detection result satisfies a previously set third game condition, the instruction unit 48 functions as a third instruction unit which instructs the player to move the hand in the third direction (Y-axis direction), e.g., in a front-to-back direction or a back-to-front direction with respect to the game machine. Here, the game conditions are conditions which are set based on a big winning lottery result, for example. When the performance command shows a performance that is executed corresponding to the player moving the hand along the specific moving direction, the instruction unit 48 instructs the player to move the hand in the specific moving direction. The instruction unit 48 may make the display device 14 display a request screen which requests the player to move the hand in the specific moving direction.

The image parameter acquiring unit 60 acquires an image parameter outputted from the image processing device 100 in response to the request command. When there is a need to detect movement of the subject in the Z-axis direction in order to determine whether or not to execute a performance, the image parameter acquiring unit 60 acquires the area and the luminance of the subject as the image parameters from the image processing device 100. When there is a need to detect movement of the subject in the X-axis direction or the Y-axis direction in order to determine whether or not to execute a performance, the image parameter acquiring unit 60 acquires the X-coordinate or the Y-coordinate of the gravity center of the subject as the image parameter from the image processing device 100.

The luminance variation amount deriving unit 62 derives a difference in luminance of the subject from one image and the other image prior thereto, to derive a luminance variation amount. The area variation amount deriving unit 64 derives a difference in area of the subject between one image and the other image prior thereto, to derive an area variation amount. The first movement variation amount deriving unit 66 derives a variation amount of the X-coordinate of the gravity center of the subject in each of one image and the other image prior thereto, as a variation amount of movement of the subject along the X-axis direction. The second movement variation amount deriving unit 68 derives a variation amount of the Y-coordinate of the gravity center of the subject in each of one image and the other image prior thereto, as a variation amount of movement of the subject along the Y-axis direction.

Based on the image parameter acquired by the image parameter acquiring unit 60, the movement detecting unit 70 detects movement of the subject along the moving direction that is shown by the execution condition, which is held in the holding unit 46 while mapped with the executable performance. The performance executing unit 50 executes the executable performance when the image parameter acquired by the image parameter acquiring unit 60 satisfies the execution condition that is held in the execution condition holding unit 46 while mapped with the executable performance. The performance executing unit 50 may execute the executable performance when the movement detecting unit 70 detects movement of the subject.

The performance executing unit 50 executes a performance in accordance with the performance command. In the case of the performance that is executed corresponding to that the player has moved the hand in the specific moving direction, the performance executing unit 50 executes a performance based on a result of movement detection by the movement detecting unit 70. The display device controller 52 makes the display device 14 display a performance screen in accordance with the performance command. The sound device controller 54 makes the acoustic device 22 output a performance sound in accordance with the performance command. When the movement detecting unit 70 detects movement of the hand along the specific moving direction which corresponds to the instruction unit 48 instructing the player to move the hand in the specific moving direction, the performance executing unit 50 may execute a performance corresponding to the specific moving direction.

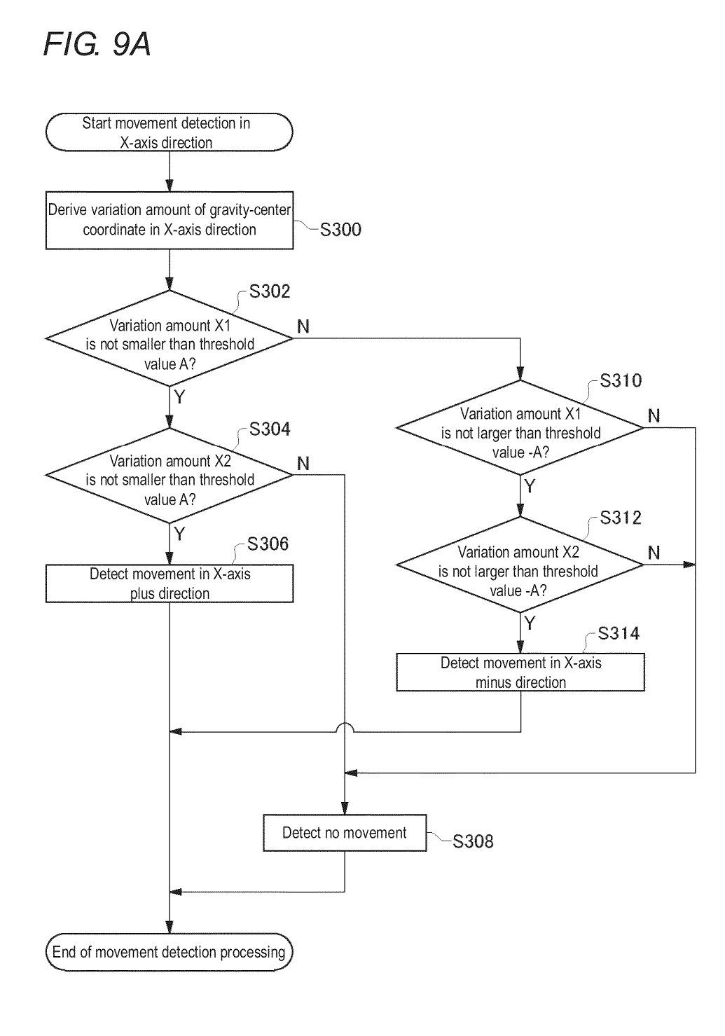

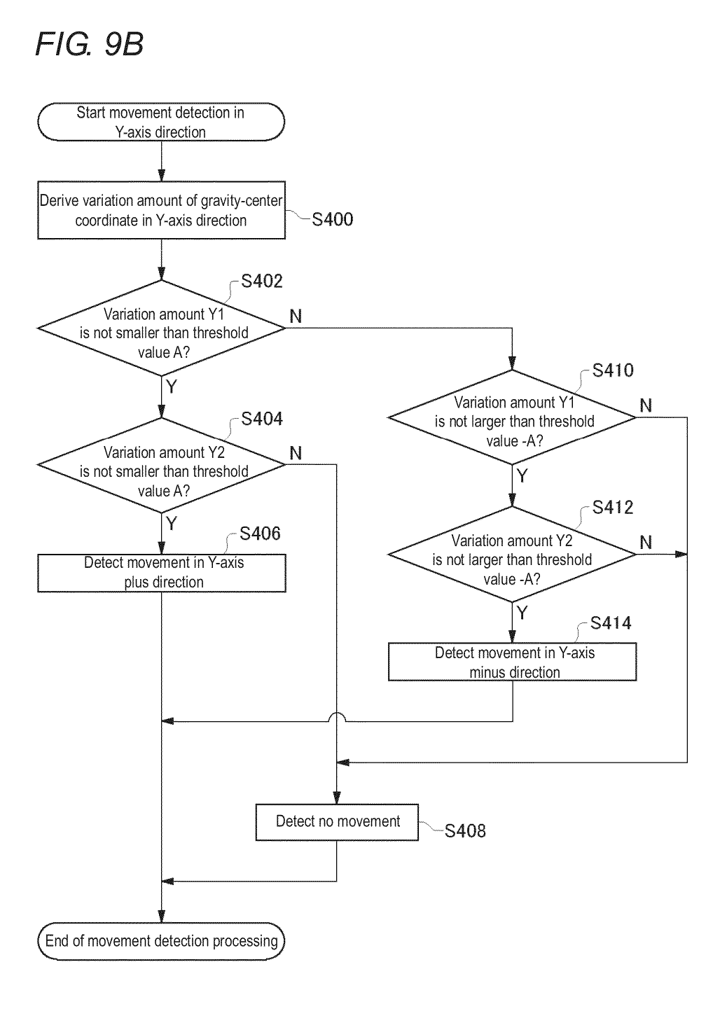

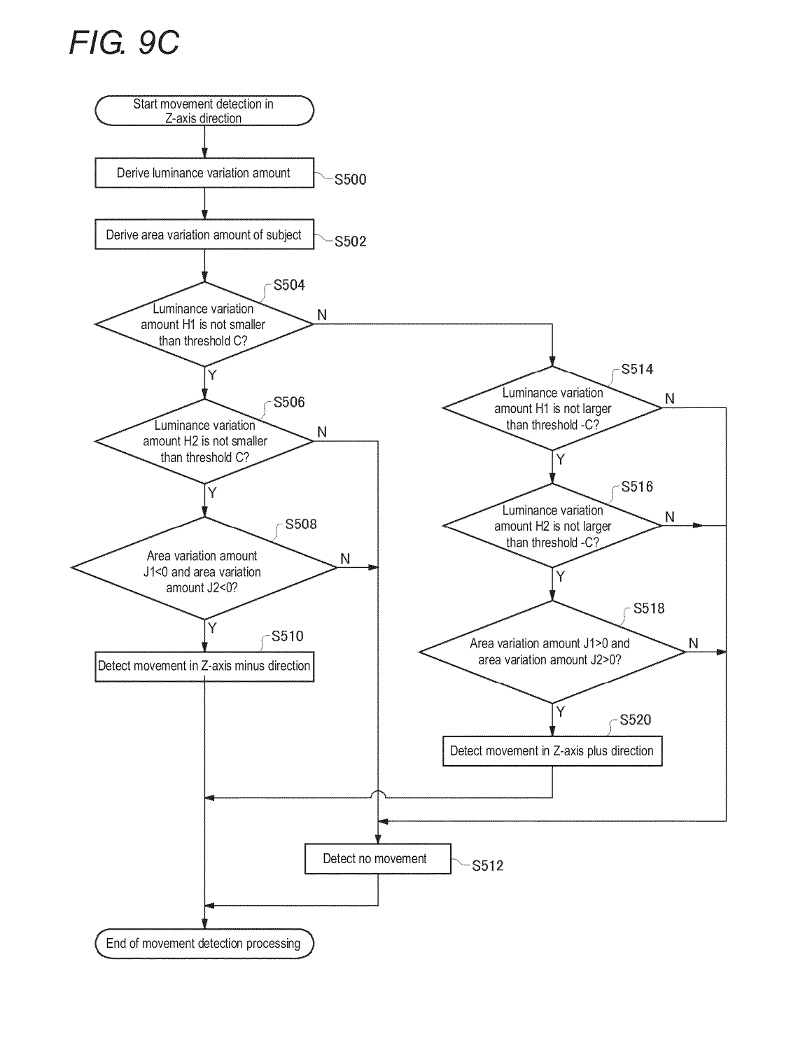

FIG. 9A shows a flowchart showing an example of a processing procedure in the case of the movement detecting unit 70 detecting movement of the subject along the X-axis direction.

The first movement variation amount deriving unit 66 derives a variation amount of the gravity-center coordinate in the X-axis direction based on the X-coordinate of the gravity center of the subject in each of the plurality of images acquired by the image parameter acquiring unit 60 (S300). The first movement variation amount deriving unit 66 derives a difference between an X-coordinate x1 of the gravity center of the subject included in the latest image and an X-coordinate x2 of the gravity center of the subject included in an image which is one image prior to the latest image, as a variation amount X1 (x1-x2) of movement along the X-axis direction. Further, the first movement variation amount deriving unit 66 derives a difference between the X-coordinate x2 of the gravity center of the subject included in the image which is one image prior to the latest image and an X-coordinate x3 of the gravity center of the subject included in an image which is two images prior to the latest image, as a variation amount X2 (x2-x3) of movement along the X-axis direction.

Subsequently, the movement detecting unit 70 determines whether or not the variation amount X1 is not smaller than the threshold A (S302). That is, the movement detecting unit 70 determines whether or not the subject has moved in an X-axis plus direction between the image I2 and the image I1. When the variation amount X1 is not smaller than the threshold A, the movement detecting unit 70 further determines whether or not the variation amount X2 is not smaller than the threshold A (S304). When the variation amount X2 is not smaller than the threshold A, since the subject is likely to have moved in the X-axis plus direction between the image I3 and the image I1, the movement detecting unit 70 detects movement of the subject in the X-axis plus direction (S306), and completes the movement detection processing. On the other hand, when the variation amount X2 is smaller than the threshold A, since the subject is unlikely to have moved in the X-axis plus direction between the image I3 and the image I1, the movement detecting unit 70 determines that the subject has not moved in the X-axis plus direction (S308), and completes the movement detection processing.

When the variation amount X1 is smaller than the threshold A, the movement detecting unit 70 determines whether or not the variation amount X1 is not larger than the threshold −A (S310). That is, the movement detecting unit 70 determines whether or not the subject has moved in an X-axis minus direction between the image I2 and the image I1. When the variation amount X1 is not larger than the threshold −A, the movement detecting unit 70 determines whether or not the variation amount X2 is not larger than the threshold −A (S312). When the variation amount X2 is not larger than the threshold −A, since the subject is likely to have moved in the X-axis minus direction between the image I3 and the image I1, the movement detecting unit 70 detects movement of the subject in the X-axis minus direction (S314), and completes the movement detection processing.

When the variation amount X1 or the variation amount X2 is larger than the threshold −A, the movement detecting unit 70 determines that the subject has not moved in the X-axis minus direction (S308), and completes the movement detection processing.

FIG. 9B shows a flowchart showing an example of a processing procedure in the case of the movement detecting unit 70 detecting movement of the subject along the Y-axis direction.

The second movement variation amount deriving unit 68 derives a variation amount of the gravity-center coordinate in the Y-axis direction based on the Y-coordinate of the gravity center of the subject in each of the plurality of images acquired by the image parameter acquiring unit 60 (S400). The second movement variation amount deriving unit 68 derives a difference between a Y-coordinate y1 of the gravity center of the subject included in the latest image and a Y-coordinate y2 of the gravity center of the subject included in an image which is one image prior to the latest image, as a variation amount Y1 (=y1-y2) of movement along the Y-axis direction. Further, the second movement variation amount deriving unit 68 derives a difference between the Y-coordinate Y2 of the gravity center of the subject included in the image which is one image prior to the latest image and a Y-coordinate Y3 of the gravity center of the subject included in an image which is two images prior to the latest image, as a variation amount Y2 (=y2-y3) of movement along the Y-axis direction.

The movement detecting unit 70 determines whether or not the variation amount Y1 is not smaller than the threshold A (S402). That is, the movement detecting unit 70 determines whether or not the subject has moved in a Y-axis plus direction between the image I2 and the image I1. When the variation amount Y1 is not smaller than the threshold A, the movement detecting unit 70 further determines whether or not the variation amount Y2 is not smaller than the threshold A (S404). When the variation amount Y2 is not smaller than the threshold A, since the subject is likely to have moved in the Y-axis plus direction between the image I3 and the image I1, the movement detecting unit 70 detects movement of the subject in the Y-axis plus direction (S406), and completes the movement detection processing. On the other hand, when the variation amount Y2 is smaller than the threshold A, since the subject is unlikely to have moved in the Y-axis plus direction between the image I3 and the image I1, the movement detecting unit 70 determines that the subject has not moved in the Y-axis plus direction (S408), and completes the movement detection processing.

When the variation amount Y1 is smaller than the threshold A, the movement detecting unit 70 determines whether or not the variation amount Y1 is not larger than the threshold −A (S410). That is, the movement detecting unit 70 determines whether or not the subject has moved in a Y-axis minus direction between the image I2 and the image I1. When the variation amount Y1 is not larger than the threshold −A, the movement detecting unit 70 determines whether or not the variation amount Y2 is not larger than the threshold −A (S412). When the variation amount Y2 is not larger than the threshold −A, since the subject is likely to have moved in the Y-axis minus direction between the image I3 and the image I1, the movement detecting unit 70 detects movement of the subject in the Y-axis minus direction (S414), and completes the movement detection processing.

When the variation amount Y1 or the variation amount Y2 is larger than the threshold −A, the movement detecting unit 70 determines that the subject has not moved in the Y-axis minus direction (S408), and completes the movement detection processing.

FIG. 9C shows a flowchart showing an example of a processing procedure in the case of the movement detecting unit 70 detecting movement of the subject along the Z-axis direction.

The luminance variation amount deriving unit 62 derives a luminance variation amount of the subject based on the luminance of the subject in each of the plurality of images acquired by the image parameter acquiring unit 60 (S500). The luminance variation amount deriving unit 62 derives a difference between a luminance E1 of the subject included in the latest image and a luminance E2 of the subject included in an image which is one image prior to the latest image, as a luminance variation amount H1 (E1-E2). Further, the luminance variation amount deriving unit 62 derives a difference between the luminance E2 of the subject included in the image which is one image prior to the latest image and a luminance E3 of the subject included in an image which is two images prior to the latest image, as a luminance variation amount H2 (E2-E3).

The area variation amount deriving unit 64 derives an area variation amount of the subject based on the area of the subject in each of the plurality of images acquired by the image parameter acquiring unit 60 (S502). The area variation amount deriving unit 64 derives a difference between an area S1 of the subject included in the latest image and an area S2 of the subject included in an image which is one image prior to the latest image, as an area variation amount J1 (S1-S2). Further, the area variation amount deriving unit 64 derives a difference between the area S2 of the subject included in the image which is one image prior to the latest image and an area S3 of the subject included in an image which is two images prior to the latest image, as an area variation amount J2 (S2-S3).

The movement detecting unit 70 determines whether or not the luminance variation amount H1 is not smaller than a threshold C (S504). That is, the movement detecting unit 70 determines whether or not the subject has become brighter between the image I2 and the image I1. When the luminance variation amount H1 is not smaller than the threshold C, the movement detecting unit 70 further determines whether or not the luminance variation amount H2 is not smaller than the threshold C (S506). When the luminance variation amount H2 is not smaller than the threshold C, the movement detecting unit 70 determines whether or not the area variation amounts J1 and J2 are smaller than zero (S508). That is, the movement detecting unit 70 determines whether or not the area of the subject gradually becomes smaller between the image I3 and the image I1.

When the area variation amounts J1 and J2 are smaller than zero, the movement detecting unit 70 detects that the subject has moved in the Z-axis plus direction, namely in a direction closer to the imaging unit 102 (S510), and completes the movement detection processing. When the variation amount H2 is smaller than the threshold C or at least one of the area variation amounts J1 and J2 is not smaller than zero, the movement detecting unit 70 determines not to have detected movement of the subject (S512), and completes the movement detection processing.

When the luminance variation amount H1 is not smaller than the threshold C, the movement detecting unit 70 determines whether or not the luminance variation amount H1 is not smaller than a threshold −C (S514). That is, the movement detecting unit 70 determines whether or not the subject has become darker between the image I2 and the image I1. When the luminance variation amount H1 is not larger than the threshold −C, the movement detecting unit 70 further determines whether or not the luminance variation amount H2 is not larger than the threshold −C (S516). When the luminance variation amount H2 is not larger than the threshold −C, the movement detecting unit 70 determines whether or not the area variation amounts J1 and J2 are larger than zero (S518). That is, the movement detecting unit 70 determines whether or not the area of the subject gradually becomes larger between the image I3 and the image I1.

When the area variation amounts J1 and J2 are larger than zero, the movement detecting unit 70 detects that the subject has moved in the Z-axis minus direction, namely in a direction away from the imaging unit 102 (S520), and completes the movement detection processing. When the variation amount H1 or H2 is larger than the threshold −C or at least one of the area variation amounts J1 and J2 is not larger than zero, the movement detecting unit 70 determines not to have detected movement of the subject (S512), and completes the movement detection processing.

As described above, the movement detecting unit 70 can more accurately detect movement of the subject along the specific moving direction based on the image parameter in accordance with the moving direction of the subject to be detected.

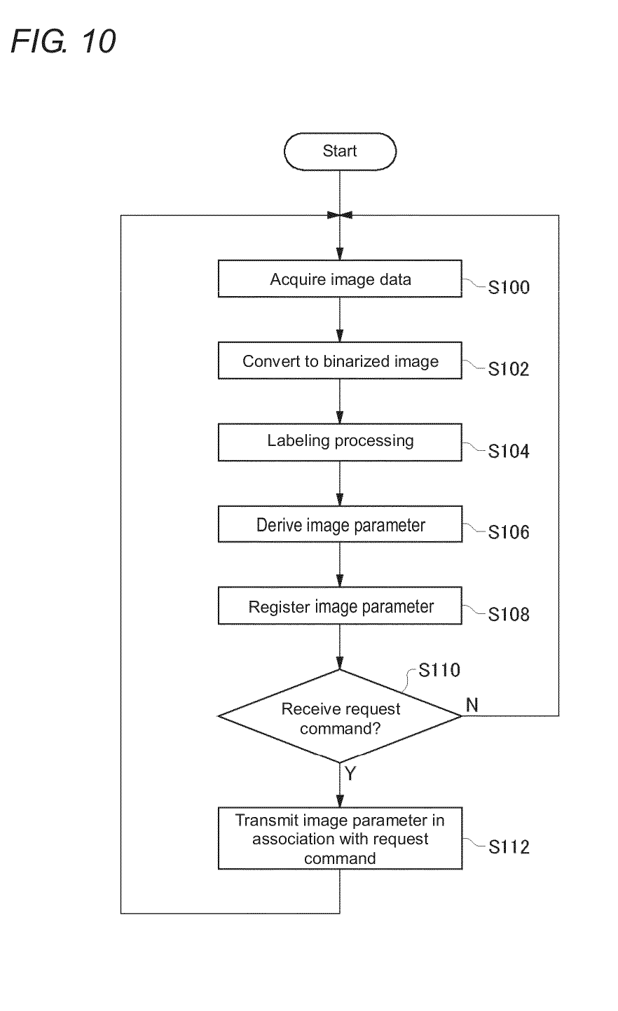

FIG. 10 is a flowchart showing an example of a processing procedure for the image processing device 100. The image processing device 100 regularly repeats this processing procedure.

The image acquiring unit 112 acquires an 8-bit grayscale image outputted from the imaging unit 102 (S100). Subsequently, the binarization converting unit 114 converts the 8-bit grayscale image to a binarized image (S102). Then, the labeling processing unit 116 executes labeling processing on the binarized image (S104). The luminance deriving unit 120, the area deriving unit 122, the first positional information deriving unit 124 and the second positional information deriving unit 126 derive the luminance of the subject, the area of the subject and the X-coordinate and the Y-coordinate of the gravity center of the subject (S106), and register the luminance of the subject, the area of the subject and the X-coordinate and the Y-coordinate of the gravity center of the subject into the image parameter holding unit 130 (S108). The transmitter/receiver 106 determines whether or not to have received a request command from the game machine 10 (S110). When not receiving the request command, the image processing device 100 sequentially updates the image parameters held in the image parameter holding unit 130.

When receiving the request command, the transmitter/receiver 106 acquires the image parameter, specified by the request command, from the image parameter holding unit 130 and transmits it to the game machine 10 (S112).

As described above, the image processing device 100 sequentially derives the image parameters necessary for detecting movement of the subject and holds them into the image parameter holding unit 130. Then, the image processing device 100 provides only the necessary image parameter to the game machine 10 in accordance with the request command from the game machine 10. The image processing device 100 may only hold the image parameters sequentially and transmit the image parameter requested as necessary. Therefore, the image processing device 100 may not have the function to execute the movement detection processing of the subject based on the image parameter. Since not needing to execute complicated processing, the image processing device 100 can be inexpensively provided. Since the image processing device 100 only provides the game machine 10 with an image parameter in accordance with a request command, there needs to be small setting change in the image processing device 100 accompanied by a pattern change on the game machine 10 side.

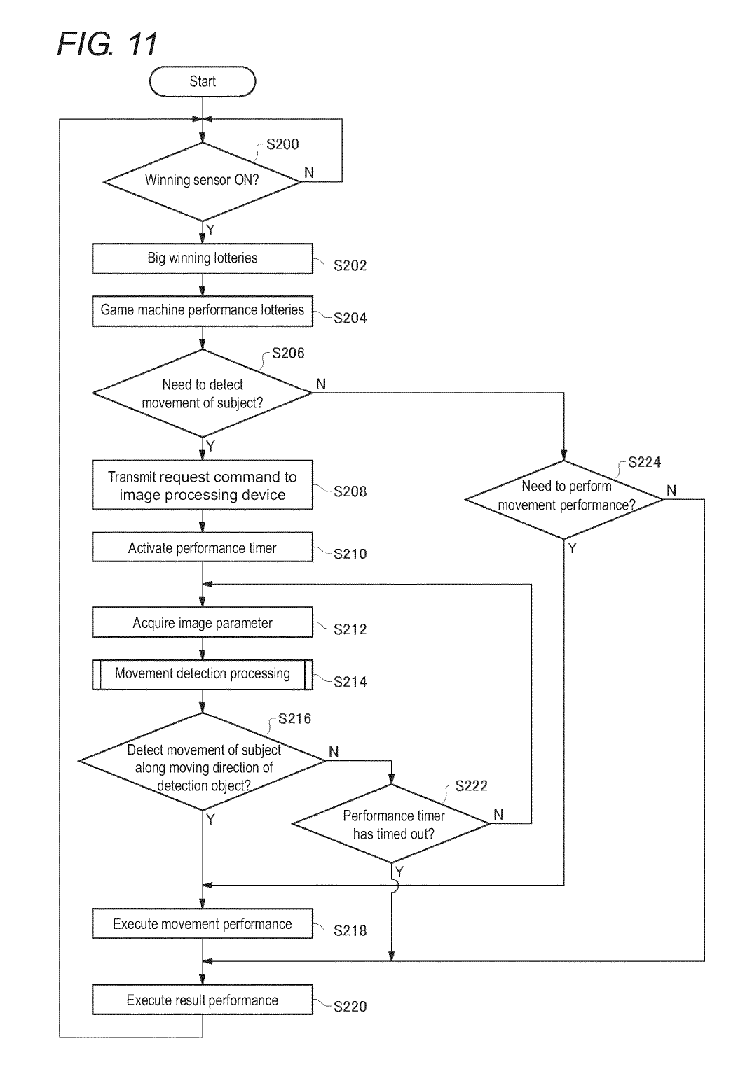

FIG. 11 shows a flowchart showing an example of a processing procedure for the game machine 10 when the game ball enters the winning hole.

When receiving a winning signal from the winning sensor 18 (S200), the input signal controller 32 makes the big winning lottery unit 36 execute big winning lotteries (S202). Upon receipt of a result of the big winning lotteries, the game machine controller 34 executes game machine performance lotteries in order to decide the content of the game machine performance (S204). As a result of the game machine performance lotteries, the game machine controller 34 transmits a performance command showing the decided performance content to the performance controller 40 via the data transmitter 38.

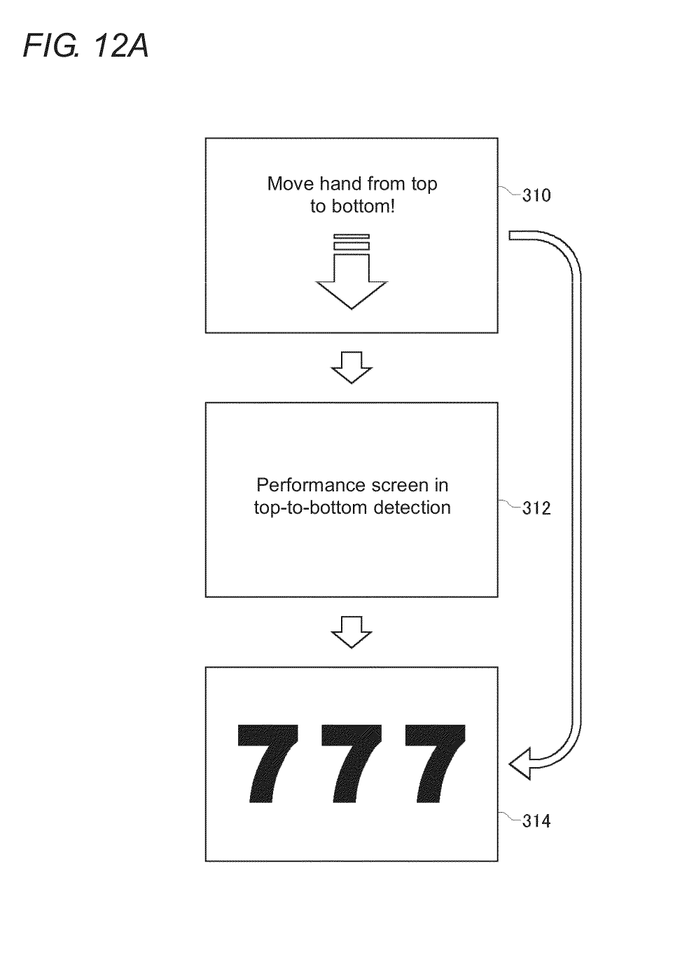

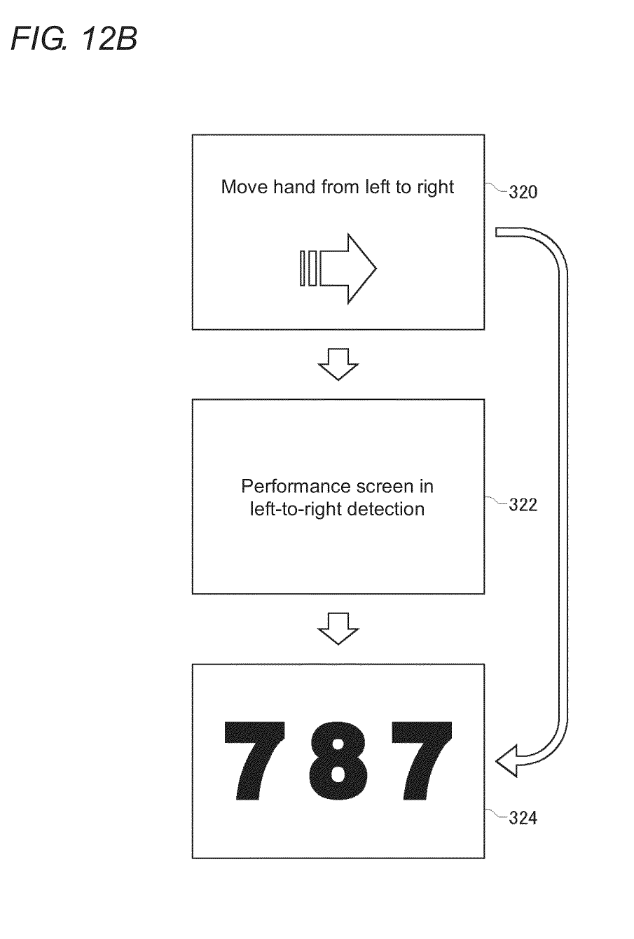

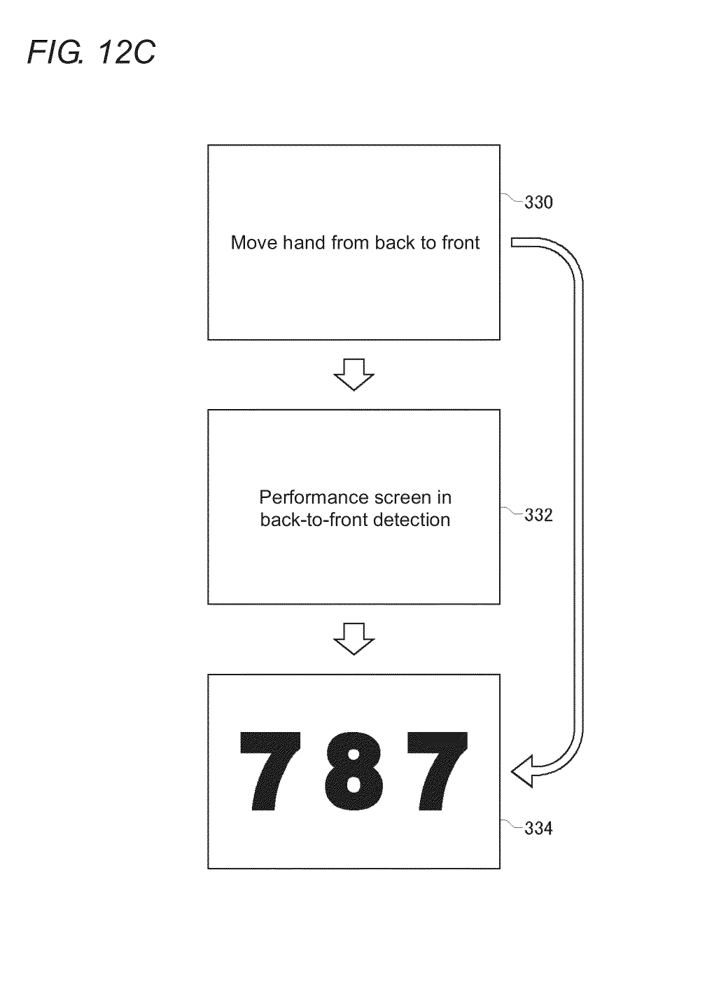

In order to execute a performance shown by the performance command, the performance controller 40 determines whether or not there is a need to detect movement of the subject (S206). When there is a need to detect movement of the moving object, such as movement of the player's hand in a specific moving direction, the instruction unit 48 makes the display device 14 display a request screen which requests the player to move the hand in the specific direction. For example, the instruction unit 48 makes the display device 14 display screens as shown in a screen 310 of FIG. 12A, a screen 320 of FIG. 12B and a screen 330 of FIG. 12C, to request the player to move the hand in the specific moving direction.

Further, in order to make a request of the image processing device 100 for the image parameter for detecting movement of the subject in the specific moving direction, the performance controller 40 transmits to the image processing device 100 a request command in accordance with the performance content (S208), and activates a performance timer (S210).

Subsequently, the performance controller 40 acquires an image parameter in accordance with the request command from the image processing device 100 (S212). The movement detecting unit 70 executes the movement detection processing based on the acquired image parameter (S214). As a result of the movement detection processing, the movement detecting unit 70 determines whether or not to have detected movement of the subject in the moving direction of the detection object (S216). When movement of the subject in the moving direction of the detection object is detected, the performance executing unit 50 executes a performance for movement detection in accordance with the moving direction of the detection object, as a movement performance (S218). The display device controller 52, for example, displays an image in which a character moves in the moving direction of the detection object, and the sound device controller 54 makes the acoustic device 22 output a sound in accordance with the image. The display device controller 52, for example, makes the display device 14 display screens in accordance with the moving direction such as a screen 312 of FIG. 12A as an example of first performance, a screen 322 of FIG. 12B as an example of second performance and a screen 332 of FIG. 12C as an example of third performance.

After execution of the movement performance in accordance with the moving direction of the detection object, the performance executing unit 50 executes a performance for lottery result for notifying of a result of big winning lotteries, as a result performance (S220). The display device controller 52 makes the display device 14 display a lottery result screen indicating the result of the big winning lotteries. The display device controller 52, for example, makes the display device 14 display lottery result screens as shown in a screen 314 of FIG. 12A, a screen 324 of FIG. 12B and a screen 334 of FIG. 12C.

When movement of the subject in the moving direction of the detection object is not detected, the performance controller 40 determines whether or not the performance timer has timed out (S222). When the performance timer has not timed out, the performance controller 40 again acquires an image parameter from the image processing device 100. When the performance timer has timed out, the performance executing unit 50 does not execute the performance for movement detection as the movement performance, but executes the performance for lottery result for notifying of a result of big winning lotteries as the result performance (S220).

When there is no need to detect movement of the moving object, the performance controller 40 determines whether or not there is a need to execute the movement performance before the result performance (S224). When there is a need to execute the movement performance, the performance executing unit 50, for example, executes such a performance as displaying a screen in which a character moves as the movement performance before notifying of the lottery result as the result performance, in a similar manner to the case of detecting movement of the subject (S218). When there is no need to execute the movement performance, the performance executing unit 50 executes the performance for lottery result as the result performance (S220).

As described above, the image processing device 100 sequentially derives all the image parameters for detecting movement of the subject in the X-axis direction, the Y-axis direction and the Z-axis direction. The game machine 10 makes a request of the image processing device 100 only for the image parameter necessary to determine whether or not to execute the performance. There is no need to provide a plurality of motion sensors in order to detect a plurality of moving directions as to the specific object such as the player's hand. This can suppress an increase in cost with addition of a plurality of motion sensors. Further, the movement detecting unit 70 detects movement of the subject in the Z-axis direction based on the area and luminance variations of the subject. Therefore, the movement detecting unit 70 can more accurately detect movement of the player's hand which moves along the Z-axis direction with the wrist taken as the base point, for example.

Although the present invention has been described above using the embodiment, the technical scope of the present invention is not restricted to the scope according to the above embodiment. It is obvious for the person skilled in the art that a variety of modification and improvement can be made in the above embodiment. It is apparent from descriptions in the claims that a form in which such modification or improvement has made can be included in the technical scope of the present invention.

It should be noted that the executing order of each processing of the operation, the procedure, the step, the stage and the like in the device, the system, the program and the method shown in the claims, the specification and the drawings is not particularly demonstrated using terms “earlier than”, “prior to” and the like, and so long as an output of some processing is not used in processing thereafter, the processing can be realized in an arbitrary order. Even when the operation flows in the claims, the specification and the drawings are described using terms “first”, “next” and the like for convenience, it does not mean that it is essential to execute the operations in this order.

A game machine according to one aspect of the present invention has been herein described a a game machine which executes a performance based on an image parameter derived by an image analyzer from an image captured by an imaging unit. The game machine is provided with: a request command holding unit configured to hold a request command for making a request of the image analyzer for an image parameter that is used for determination as to whether or not to execute a performance while mapping the image parameter with each of a plurality of performances; an execution condition holding unit configured to hold an execution condition to be satisfied by the image parameter while mapping the request command with each of the plurality of performances; a request command outputting unit configured to output to the image analyzer the request command that is held in the request command holding unit while mapped with an executable performance, when the executable performance is decided; an image parameter acquiring unit configured to acquire an image parameter that is outputted from the image analyzer in response to the request command; and a performance executing unit configured to execute the executable performance when the image parameter acquired from the image parameter acquiring unit satisfies the execution condition that is held in the execution condition holding unit, while mapped with the executable performance.

The game machine according to the disclosed embodiment is further provided with a movement detecting unit configured to detect movement of a subject included in the image based on the image parameter acquired by the image parameter acquiring unit. The request command holding unit may hold a request command for making a request of the image analyzer for an image parameter for the movement detecting unit to detect movement of the subject along a moving direction corresponding to each of the plurality of performances, the execution condition holding unit may hold as the execution condition a condition showing a moving direction in which the subject is to move while mapping the condition with each of the plurality of performances, the movement detecting unit may detect movement of the subject along the moving direction shown by the execution condition that is held in the execution condition holding unit, while mapped with the executable performance, based on the image parameter acquired by the image parameter acquiring unit, and the performance executing unit may execute the executable performance when the movement detecting unit detects movement of the subject.

In the exemplary game machine, the image analyzer may be provided with: a subject specifying unit configured to specify the subject included in the image; an area deriving unit configured to derive an area of the subject in the image; and a luminance deriving unit configured to derive a luminance of the subject in the image, the request command holding unit may hold a first request command for making a request of the image analyzer for the area and the luminance of the subject as the image parameters while mapping the first request command with a first performance that is executed when the subject moves along a first direction vertical to the imaging surface of the imaging unit, the execution condition holding unit may hold as the execution condition a condition showing the first direction while mapping the condition with the first performance, the request command outputting unit may output the first request command to the image analyzer when the first performance is decided as the executable performance, the image parameter acquiring unit may acquire as the image parameters the area and the luminance of the subject in each of the plurality of images consecutively captured by the imaging unit, the images being outputted from the image analyzer in response to the first request command, the movement detecting unit may detect movement of the subject along the first direction based on the area and the luminance of the subject in each of the plurality of images, and the performance executing unit may execute the first performance when the movement detecting unit detects movement of the subject along the first direction.

In the described game machine, the movement detecting unit may detect that the subject moves in a direction closer to the imaging unit along the first direction when the area of the subject varies to be smaller and the luminance of the object varies to be higher.

As described, the movement detecting unit may detect that the subject moves in a direction away from the imaging unit along the first direction when the area of the subject varies to be larger and the luminance of the object varies to be lower.

The game machine of the invention is further provided with a first instruction unit configured to instruct the player to move his or her hand in the first direction when a previously set first game condition is satisfied. The request command outputting unit may output the first request command when the first instruction unit instructs the player to move the hand in the first direction, and the performance executing unit may execute the first performance when the movement detecting unit detects movement of the hand along the first direction in accordance with the first instruction unit instructing the player to move the hand in the first direction.

As described, the image analyzer may be provided with a first positional information deriving unit configured to derive first positional information showing a position of the subject along a second direction parallel to the imaging surface of the subject in the image, the request command holding unit may hold a second request command for making a request of the image analyzer for the first positional information as the image parameter while mapping the second request command with a second performance that is executed when the subject moves along the second direction, the execution condition holding unit may hold as the execution condition a condition showing the second direction while mapping the condition with the second performance, the request command outputting unit may output the second request command to the image analyzer when the second performance is decided as the executable performance, the image parameter acquiring unit may acquire as the image parameter the first positional information of the subject in each of the plurality of images that are outputted from the image analyzer in response to the second request command, the movement detecting unit may detect movement of the subject along the second direction based on the first positional information in each of the plurality of images, and the performance executing unit may execute the second performance when the movement detecting unit detects movement of the subject along the second direction.

The game machine is further provided with a second instruction unit configured to instruct the player to move his or her hand in the second direction when a previously set second game condition is satisfied. The request command outputting unit may output the second request command when the second instruction unit instructs the player to move the hand in the second direction, and the performance executing unit may execute the second performance when the movement detecting unit detects movement of the hand along the second direction in accordance with the second instruction unit instructing the player to move the hand in the second direction.

In the game machine, the image analyzer may be provided with a second positional information deriving unit configured to derive second positional information showing a position of the subject along a third direction which is parallel to the imaging surface of the subject in the image and is different from the second direction, the request command holding unit may hold a third request command for making a request of the image analyzer for the second positional information as the image parameter while mapping the third request command with a third performance that is executed when the subject moves along the third direction, the execution condition holding unit may hold as the execution condition a condition showing the third direction while mapping the condition with the third performance, the request command outputting unit may output the third request command to the image analyzer when the third performance is decided as the executable performance, the image parameter acquiring unit may acquire as the image parameter the second positional information of the subject in each of the plurality of images that are outputted from the image analyzer in response to the third request command, the movement detecting unit may detect movement of the subject along the third direction based on the second positional information in each of the plurality of images, and the performance executing unit may execute the third performance when the movement detecting unit detects movement of the subject along the third direction.

The illustrative game machine is further provided with a third instruction unit configured to instruct the player to move his or her hand in the third direction when a previously set third game condition is satisfied. The request command outputting unit may output the third request command to the image analyzer when the third instruction unit instructs the player to move the hand in the third direction, and the performance executing unit may execute the third performance when the movement detecting unit detects movement of the hand along the third direction in accordance with the third instruction unit instructing the player to move the hand in the third direction.

In the game machine, when the image parameter acquired by the image parameter acquiring unit satisfies the execution condition that is held in the execution condition holding unit while mapped with the executable performance, the performance executing unit may execute one performance as the executable performance and subsequently executes another performance, and when the image parameter acquired by the image parameter acquiring unit does not satisfy the execution condition, which is held in the execution condition holding unit while mapped with the executable performance, the performance executing unit may not execute the one performance but execute another performance.

It is to be noted that the above summary of the invention is not one enumerating all required characteristics of the present invention. Further, a sub-combination of a group of these characteristics can also be an invention.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A game machine which executes a performance based on an image parameter derived by an image analyzer from an image captured by an imaging unit, the game machine comprising:
a request command holding unit configured to hold a request command for making a request of the image analyzer for an image parameter that is used for determination as to whether or not to execute a performance, while mapping the image parameter with each of a plurality of performances;
an execution condition holding unit configured to hold an execution condition to be satisfied by the image parameter, while mapping the request command with each of the plurality of performances;
a request command outputting unit configured to output to the image analyzer the request command that is held in the request command holding unit while mapped with an executable performance, when the executable performance is decided;
an image parameter acquiring unit configured to acquire an image parameter that is outputted from the image analyzer in response to the request command; and
a performance executing unit configured to execute the executable performance when the image parameter acquired from the image parameter acquiring unit satisfies the execution condition that is held in the execution condition holding unit while mapped with the executable performance.

2. The game machine according to claim 1, further comprising:
a movement detecting unit configured to detect movement of a subject included in the image based on the image parameter acquired by the image parameter acquiring unit,
wherein the request command holding unit is configured to hold a request command for making a request of the image analyzer for an image parameter for the movement detecting unit to detect movement of the subject along a moving direction corresponding to each of the plurality of performances,
the execution condition holding unit is configured to hold as the execution condition a condition showing a moving direction in which the subject is to move, while mapping the condition with each of the plurality of performances,
the movement detecting unit is configured to detect movement of the subject along the moving direction shown by the execution condition that is held in the execution condition holding unit while mapped with the executable performance, based on the image parameter acquired by the image parameter acquiring unit, and
the performance executing unit is configured to execute the executable performance when the movement detecting unit detects movement of the subject.

3. The game machine according to claim 2,
wherein the image analyzer comprises:
a subject specifying unit configured to specify the subject included in the image;
an area deriving unit configured to derive an area of the subject in the image; and
a luminance deriving unit configured to derive a luminance of the subject in the image,
the request command holding unit is configured to hold a first request command for making a request of the image analyzer for the area and the luminance of the subject as the image parameters, while mapping the first request command with a first performance that is executed when the subject moves along a first direction vertical to the imaging surface of the imaging unit,
the execution condition holding unit is configured to hold as the execution condition a condition showing the first direction, while mapping the condition with the first performance,
the request command outputting unit is configured to output the first request command to the image analyzer when the first performance is decided as the executable performance,
the image parameter acquiring unit is configured to acquire as the image parameters the area and the luminance of the subject in each of the plurality of images consecutively captured by the imaging unit, the images being outputted from the image analyzer in response to the first request command,
the movement detecting unit is configured to detect movement of the subject along the first direction based on the area and the luminance of the subject in each of the plurality of images, and
the performance executing unit is configured to execute the first performance when the movement detecting unit detects movement of the subject along the first direction.

4. The game machine according to claim 3, wherein the movement detecting unit is configured to detect that the subject moves in a direction closer to the imaging unit along the first direction when the area of the subject varies to be smaller and the luminance of the object varies to be higher.

5. The game machine according to claim 3, wherein the movement detecting unit is configured to detect that the subject moves in a direction away from the imaging unit along the first direction when the area of the subject varies to be larger and the luminance of the object varies to be lower.

6. The game machine according to claim 3, further comprising:
a first instruction unit configured to instruct the player to move his or her hand in the first direction when a previously set first game condition is satisfied
wherein the request command outputting unit is configured to output the first request command when the first instruction unit instructs the player to move the hand in the first direction, and
the performance executing unit is configured to execute the first performance when the movement detecting unit detects movement of the hand along the first direction in accordance with the first instruction unit instructing the player to move the hand in the first direction.

7. The game machine according to claim 3, wherein
the image analyzer comprises:
a first positional information deriving unit configured to derive first positional information showing a position of the subject along a second direction parallel to the imaging surface of the subject in the image,
the request command holding unit is configured to hold a second request command for making a request of the image analyzer for the first positional information as the image parameter, while mapping the second request command with a second performance that is executed when the subject moves along the second direction,
the execution condition holding unit is configured to hold as the execution condition a condition showing the second direction, while mapping the condition with the second performance,
the request command outputting unit is configured to output the second request command to the image analyzer when the second performance is decided as the executable performance,
the image parameter acquiring unit is configured to acquire as the image parameter the first positional information of the subject in each of the plurality of images that are outputted from the image analyzer in response to the second request command,
the movement detecting unit is configured to detect movement of the subject along the second direction based on the first positional information in each of the plurality of images, and
the performance executing unit is configured to execute the second performance when the movement detecting unit detects movement of the subject along the second direction.

8. The game machine according to claim 7, further comprising:
a second instruction unit configured to instruct the player to move his or her hand in the second direction when a previously set second game condition is satisfied,
wherein the request command outputting unit is configured to output the second request command when the second instruction unit instructs the player to move the hand in the second direction, and
the performance executing unit is configured to execute the second performance when the movement detecting unit detects movement of the hand along the second direction in accordance with the second instruction unit instructing the player to move the hand in the second direction.

9. The game machine according to claim 7, wherein
the image analyzer comprises:
a second positional information deriving unit configured to derive second positional information showing a position of the subject along a third direction which is parallel to the imaging surface of the subject in the image and is different from the second direction,
the request command holding unit is configured to hold a third request command for making a request of the image analyzer for the second positional information as the image parameter, while mapping the third request command with a third performance that is executed when the subject moves along the third direction,
the execution condition holding unit is configured to hold as the execution condition a condition showing the third direction, while mapping the condition with the third performance,
the request command outputting unit is configured to output the third request command to the image analyzer when the third performance is decided as the executable performance,
the image parameter acquiring unit is configured to acquire as the image parameter the second positional information of the subject in each of the plurality of images that are outputted from the image analyzer in response to the third request command,
the movement detecting unit is configured to detect movement of the subject along the third direction based on the second positional information in each of the plurality of images, and
the performance executing unit is configured to execute the third performance when the movement detecting unit detects movement of the subject along the third direction.

10. The game machine according to claim 9, further comprising:
a third instruction unit configured to instruct the player to move his or her hand in the third direction when a previously set third game condition is satisfied,
wherein the request command outputting unit is configured to output the third request command to the image analyzer when the third instruction unit instructs the player to move the hand in the third direction, and
the performance executing unit is configured to execute the third performance when the movement detecting unit detects movement of the hand along the third direction in accordance with the third instruction unit instructing the player to move the hand in the third direction.

11. The game machine according to claim 1, wherein,
when the image parameter acquired by the image parameter acquiring unit satisfies the execution condition that is held in the execution condition holding unit while mapped with the executable performance, the performance executing unit is configured to execute one performance as the executable performance and subsequently execute another performance, and
when the image parameter acquired by the image parameter acquiring unit does not satisfy the execution condition, which is held in the execution condition holding unit while mapped with the executable performance, the performance executing unit is configured not to execute the one performance and executes the other performance.

12. The game machine according to claim 4, wherein the movement detecting unit is configured to detect that the subject moves in a direction away from the imaging unit along the first direction when the area of the subject varies to be larger and the luminance of the object varies to be lower.

13. The game machine according to claim 4, further comprising:
a first instruction unit configured to instruct the player to move his or her hand in the first direction when a previously set first game condition is satisfied
wherein the request command outputting unit is configured to output the first request command when the first instruction unit instructs the player to move the hand in the first direction, and
the performance executing unit is configured to execute the first performance when the movement detecting unit detects movement of the hand along the first direction in accordance with the first instruction unit instructing the player to move the hand in the first direction.

14. The game machine according to claim 5, further comprising:
a first instruction unit configured to instruct the player to move his or her hand in the first direction when a previously set first game condition is satisfied
wherein the request command outputting unit is configured to output the first request command when the first instruction unit instructs the player to move the hand in the first direction, and
the performance executing unit is configured to execute the first performance when the movement detecting unit detects movement of the hand along the first direction in accordance with the first instruction unit instructing the player to move the hand in the first direction.

15. The game machine according to claim 12, further comprising:
a first instruction unit configured to instruct the player to move his or her hand in the first direction when a previously set first game condition is satisfied
wherein the request command outputting unit is configured to output the first request command when the first instruction unit instructs the player to move the hand in the first direction, and
the performance executing unit is configured to execute the first performance when the movement detecting unit detects movement of the hand along the first direction in accordance with the first instruction unit instructing the player to move the hand in the first direction.

16. The game machine according to claim 4, wherein
the image analyzer comprises:
a first positional information deriving unit configured to derive first positional information showing a position of the subject along a second direction parallel to the imaging surface of the subject in the image,
the request command holding unit is configured to hold a second request command for making a request of the image analyzer for the first positional information as the image parameter, while mapping the second request command with a second performance that is executed when the subject moves along the second direction,
the execution condition holding unit is configured to hold as the execution condition a condition showing the second direction, while mapping the condition with the second performance,
the request command outputting unit is configured to output the second request command to the image analyzer when the second performance is decided as the executable performance,
the image parameter acquiring unit is configured to acquire as the image parameter the first positional information of the subject in each of the plurality of images that are outputted from the image analyzer in response to the second request command,
the movement detecting unit is configured to detect movement of the subject along the second direction based on the first positional information in each of the plurality of images, and
the performance executing unit is configured to execute the second performance when the movement detecting unit detects movement of the subject along the second direction.

17. The game machine according to claim 5, wherein
the image analyzer comprises:
a first positional information deriving unit configured to derive first positional information showing a position of the subject along a second direction parallel to the imaging surface of the subject in the image,
the request command holding unit is configured to hold a second request command for making a request of the image analyzer for the first positional information as the image parameter, while mapping the second request command with a second performance that is executed when the subject moves along the second direction,
the execution condition holding unit is configured to hold as the execution condition a condition showing the second direction, while mapping the condition with the second performance,
the request command outputting unit is configured to output the second request command to the image analyzer when the second performance is decided as the executable performance,
the image parameter acquiring unit is configured to acquire as the image parameter the first positional information of the subject in each of the plurality of images that are outputted from the image analyzer in response to the second request command,
the movement detecting unit is configured to detect movement of the subject along the second direction based on the first positional information in each of the plurality of images, and
the performance executing unit is configured to execute the second performance when the movement detecting unit detects movement of the subject along the second direction.

18. The game machine according to claim 6, wherein
the image analyzer comprises:
a first positional information deriving unit configured to derive first positional information showing a position of the subject along a second direction parallel to the imaging surface of the subject in the image,
the request command holding unit is configured to hold a second request command for making a request of the image analyzer for the first positional information as the image parameter, while mapping the second request command with a second performance that is executed when the subject moves along the second direction,
the execution condition holding unit is configured to hold as the execution condition a condition showing the second direction, while mapping the condition with the second performance,
the request command outputting unit is configured to output the second request command to the image analyzer when the second performance is decided as the executable performance,
the image parameter acquiring unit is configured to acquire as the image parameter the first positional information of the subject in each of the plurality of images that are outputted from the image analyzer in response to the second request command,
the movement detecting unit is configured to detect movement of the subject along the second direction based on the first positional information in each of the plurality of images, and
the performance executing unit is configured to execute the second performance when the movement detecting unit detects movement of the subject along the second direction.

19. The game machine according to claim 12, wherein
the image analyzer comprises:
a first positional information deriving unit configured to derive first positional information showing a position of the subject along a second direction parallel to the imaging surface of the subject in the image,
the request command holding unit is configured to hold a second request command for making a request of the image analyzer for the first positional information as the image parameter, while mapping the second request command with a second performance that is executed when the subject moves along the second direction,
the execution condition holding unit is configured to hold as the execution condition a condition showing the second direction, while mapping the condition with the second performance,
the request command outputting unit is configured to output the second request command to the image analyzer when the second performance is decided as the executable performance,
the image parameter acquiring unit is configured to acquire as the image parameter the first positional information of the subject in each of the plurality of images that are outputted from the image analyzer in response to the second request command,
the movement detecting unit is configured to detect movement of the subject along the second direction based on the first positional information in each of the plurality of images, and
the performance executing unit is configured to execute the second performance when the movement detecting unit detects movement of the subject along the second direction.

20. The game machine according to claim 13, wherein
the image analyzer comprises:
a first positional information deriving unit configured to derive first positional information showing a position of the subject along a second direction parallel to the imaging surface of the subject in the image,
the request command holding unit is configured to hold a second request command for making a request of the image analyzer for the first positional information as the image parameter, while mapping the second request command with a second performance that is executed when the subject moves along the second direction,
the execution condition holding unit is configured to hold as the execution condition a condition showing the second direction, while mapping the condition with the second performance,
the request command outputting unit is configured to output the second request command to the image analyzer when the second performance is decided as the executable performance,
the image parameter acquiring unit is configured to acquire as the image parameter the first positional information of the subject in each of the plurality of images that are outputted from the image analyzer in response to the second request command,
the movement detecting unit is configured to detect movement of the subject along the second direction based on the first positional information in each of the plurality of images, and
the performance executing unit is configured to execute the second performance when the movement detecting unit detects movement of the subject along the second direction.
